(19) United States
(12) Patent Application Publication
(10) Pub. No.: US 2020/0210496 A1
(43) Pub. Date: Jul. 2, 2020

(54) DISTRIBUTED SEARCH METHOD, INDEX UPDATE METHOD, SYSTEM, SERVER, AND COMPUTER DEVICE

(71) Applicant: Beijing Sankuai Online Technology Co., Ltd, Beijing (CN)

(72) Inventors: Ruofei DU, Beijing (CN); Wenbin PAN, Beijing (CN); Xilun ZHANG, Beijing (CN)

(21) Appl. No.: 16/622,298

(22) PCT Filed: Dec. 29, 2017
(86) PCT No.: PCT/CN2017/120018

§ 371 Date: Dec. 13, 2019

(30) Foreign Application Priority Data
Jul. 5, 2017 (CN) 201710540135.0

(51) Int. Cl. G06F 16/953; H04L 29/08; G06F 16/951

(52) U.S. Cl. CPC G06F 16/953; G06F 16/951; H04L 67/28

(57) ABSTRACT

Provided is a distributed search method, an index update method, a system, a server, and a computer device. After receiving a query request from a terminal device forwarded by a query server, at least one of a plurality of proxy servers queries a configuration management server according to attribute information corresponding to the query request to obtain machine information corresponding to the attribute information, and send the query request to at least two engine servers corresponding to the machine information. And after obtaining first query results returned by the at least two engine servers in response to the query request, the at least one proxy server merges at least two of the first query results into a second query result according to a preset rule, and send the second query result to the query server, so that the query server returns the second query result to the terminal device.

### CROSS-REFERENCE TO RELATED APPLICATIONS

This application claims priority to Chinese Patent Application No. 201710540135.0, filed with the Chinese Patent Office on Jul. 5, 2017 and entitled “DISTRIBUTED SEARCH METHOD, INDEX UPDATE METHOD, SYSTEM, SERVER, AND COMPUTER DEVICE”, which is incorporated herein by reference in its entirety.

### TECHNICAL FIELD

The present disclosure relates to a distributed search method, an index update method, a system, a server, and a computer device.

### BACKGROUND

With the development of mobile internet, people can conveniently access the internet with mobile devices to obtain internet services, and a number of online-to-offline (O2O) local life services have emerged. However, with the explosive growth of services, search engines need to handle an increasingly large amount of query data, and such data already becomes too large to be stored in the memory of a single computer. As a result, system stability becomes increasingly low, query requests are susceptible to increasingly high latency, and user experience becomes increasingly poor.

Searches, indexes, and an index maintenance program may be placed on one server. Alternatively, indexes may be distributed on a plurality of machines, and an engine is responsible for index management. However, real-time extension may fail when a large number of concurrent searches occur. In addition, as service traffic grows, an increasing large number of indexes are needed, and operation and maintenance costs keep increasing, and online stability is affected.

A distributed search system using a master-slave structure may be used. However, a master server needs to be elected. When a master server encounters an exception and fails, it is necessary to reelect a master server. As a result, a search service is unavailable in the process of reelecting a master server, leading to affected online stability.

### SUMMARY

To solve deficiencies in the related art, embodiments of the present disclosure provide a distributed search method, an index update method, a system, a server, and a computer device.

According to a first aspect of the present disclosure, a distributed search method is provided, including: obtaining, by at least one first proxy server of a plurality of proxy servers after receiving a query request from a query server, attribute information corresponding to the query request; querying, by the first proxy server, a configuration management server based on the attribute information to obtain machine information corresponding to the attribute information; sending, by the first proxy server, the query request to at least two engine servers corresponding to the machine information; obtaining, by the first proxy server, first query results returned by the at least two engine servers according to the query request; merging, by the first proxy server, at least two of the first query results into a second query result according to a preset rule; and sending, by the first proxy server, the second query result to the query server.

According to a second aspect of the present disclosure, an index update method is provided, including: obtaining, by a master control server, a splitting rule from a configuration management server; sending, by the master control server, the splitting rule to an index creation server, so that the index creation server splits to-be-created index data according to the splitting rule; obtaining, by the master control server, index configuration information representing a splitting result; obtaining, by the master control server, index data based on the index configuration information; and storing, by the master control server, the index data in at least two corresponding engine servers of a plurality of engine servers.

According to a third aspect of the present disclosure, a proxy server is provided, including: a communication unit, configured to receive a query request from a query server; and a processing unit, configured to: obtain attribute information corresponding to the query request, query a configuration management server based on the attribute information to obtain machine information corresponding to the attribute information, and determine at least two engine servers corresponding to the machine information. The communication unit is further configured to send the query request to the at least two engine servers to obtain first query results returned by the at least two engine servers according to the query request. The processing unit is further configured to merge at least two of the first query results according to a preset rule to obtain a second query result. The communication unit is further configured to send the second query result to the query server.

According to a fourth aspect of the present disclosure, a master control server is provided, including: a master control module, configured to obtain a splitting rule from a configuration management server; and a notification module, configured to send the splitting rule to an index creation server, so that the index creation server splits to-be-created index data according to the splitting rule and obtains index configuration information representing a splitting result. The master control module is further configured to: obtain index data based on the index configuration information, and store the index data in at least two corresponding engine servers of a plurality of engine servers.

According to a fifth aspect of the present disclosure, a distributed search system is provided, including: a configuration management server, configured to manage configuration information and machine information, where the configuration information includes a splitting rule, and the machine information represents information of a plurality of engine servers; a query server, configured to obtain a query request of a terminal device; a plurality of proxy servers; and a plurality of engine servers, where each of the plurality of engine servers is configured to store index data that meets the splitting rule, where after receiving the query request from the query server, at least one first proxy server of the plurality of proxy servers queries the configuration management server based on attribute information of the query request, determines at least two first engine servers of the plurality of engine servers, and sends the query request to the at least two first engine servers; the at least two first engine servers return first query results in response to the query request; and the at least one first proxy server merges at least two of the first query results into a second query result, and sends the second query result to the query server, so that the query server returns the second query result to the terminal device.

According to a sixth aspect of the present disclosure, a computer device is provided, including a memory, a processor, and computer programs stored in the memory and executable by the processor, where the processor executes the programs to implement the steps of the foregoing distributed search method.

According to a seventh aspect of the present disclosure, a computer device is provided, including a memory, a processor, and computer programs stored in the memory and executable by the processor, where the processor executes the programs to implement the steps of the foregoing index update method.

According to the technical solutions of the embodiments of the present disclosure, by means of a distributed architecture in which a query server and an engine server are linked together by a plurality of proxy servers, a query request from the query server may be sent to at least one of the plurality of proxy servers, and the at least one proxy server obtains query results from at least two corresponding engine servers. The plurality of proxy servers are in a parallel relationship. Therefore, when one proxy server fails, another proxy server may be used instead. In this way, it can be effectively avoided that a search service is temporarily unavailable when a master device fails and it is necessary to reselect a master device. In addition, a master control server links a configuration management server, an index creation server, and an engine server together to update and maintain index data, so that the proxy servers do not need to update or maintain indexes, thereby greatly reducing the load of the proxy servers.

### BRIEF DESCRIPTION OF THE DRAWINGS

FIG. 1 is a schematic flowchart of an index update method according to an embodiment of the present disclosure.

FIG. 2 is a schematic diagram of an application architecture and data exchange of a distributed search method according to an embodiment of the present disclosure.

FIG. 3 is a schematic flowchart of a distributed search method according to another embodiment of the present disclosure.

FIG. 4 is a schematic diagram of an application architecture and data exchange of a distributed search method according to another embodiment of the present disclosure.

FIG. 5 is a schematic structural diagram of a proxy server according to an embodiment of the present disclosure.

FIG. 6 is a schematic structural diagram of a master control server according to an embodiment of the present disclosure.

FIG. 7 is a schematic structural diagram of a computer device according to an embodiment of the present disclosure.

### DETAILED DESCRIPTION OF THE EMBODIMENTS

The present disclosure is further described below in detail with reference to the accompanying drawings and specific embodiments.

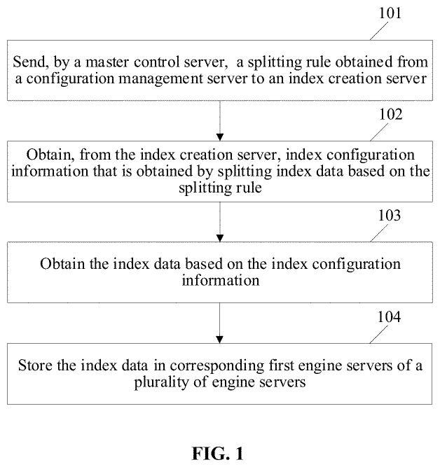

FIG. 1 is a schematic flowchart of an index update method according to an embodiment of the present disclosure. As shown in FIG. 1, the method may include the following steps.

Step 101: A master control server sends a splitting rule obtained from a configuration management server to an index creation server, so that the index creation server splits to-be-created index data into a plurality of pieces of index configuration information according to the splitting rule.

Step 102: The master control server obtains index configuration information from the index creation server.

Step 103: The master control server obtains index data based on the index configuration information.

Step 104: The master control server stores the index data in corresponding first engine servers of a plurality of engine servers to update the index data stored in the first engine servers.

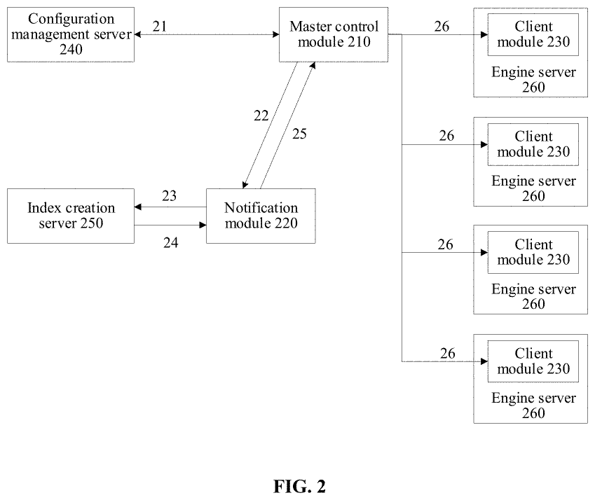

The index update method of this embodiment may be applied to a master control server. The master control server may be specifically a server or a server cluster. In an embodiment, the master control server may include a master control module 210, a notification module 220, and a plurality of client modules 230. Refer to FIG. 2 for details. The master control module 210 may be responsible for unified scheduling and communicate with a configuration management server 240. The notification module 220 may be responsible for notifying an index creation server 250. There may be one or more notification modules 220. For example, a plurality of notification modules 220 may be distinguished based on different service types to respectively notify related information for creating indexes that belong to the corresponding service types. The quantity of the client modules 230 may be the same as the quantity of the engine server 260, and each client module 230 corresponds to one engine server 260. The client module 230 may be configured to: pull index data according to an indication of the master control module 210, and store the pulled index data in the corresponding engine server 260. The master control module 210 and each notification module 220 may be implemented by independent servers. The client module 230 may be located in the corresponding engine server 260 and implements a corresponding function by using the corresponding engine server 260. During actual application, the master control module 210 may be configured with a standby master control module. Each notification module 220 may be configured with a corresponding standby notification module. Each client module 230 may be configured with a corresponding standby client module. In this way, when a master module encounters an exception and fails, a corresponding standby module can continue to perform a corresponding function.

The configuration management server 240 is configured to manage configuration information and machine information. The machine information may represent information of the plurality of engine servers 260. The information of the engine servers 260 may include information such as IP addresses and ports of the engine servers. As an example, the machine information may be represented by using a machine list including the information of the engine servers 260. The configuration information may at least include service identifiers, machine configuration information, configured rule information, and the like. The machine configuration information may specifically include the machine list, that is, include the information such as the IP addresses and ports of the engine servers 260. The rule information includes any operation rule required in a search process, and at least includes a splitting rule and an index creation rule required for index creation, a configuration rule for the notification module to provide notification information for creating an index of which service type or indexes of which service types, a configuration rule for the client module to pull index data corresponding to which service type or which service types, and the like. Certainly, the rule information is not limited to the foregoing rules.

A step that the master control server obtains a splitting rule in the configuration information from the configuration management server 240, and sends the splitting rule to the index creation server 250 may specifically include: obtaining, by the master control module 210, the splitting rule from the configuration management server 240, and certainly, obtaining an index creation rule as well; sending, by the master control module 210, the splitting rule and the index creation rule to the notification module 220; and sending, by the notification module 220, the splitting rule and the index creation rule to the index creation server 250. A plurality of notification modules 220 may be configured according to different service types. Therefore, the master control module 210 may obtain, according to a service type of to-be-created index data, a splitting rule and an index creation rule that match the service type from the configuration management server 240, and send the splitting rule and the index creation rule to a notification module 220 that matches the service type. The notification module 220 then sends the splitting rule and the index creation rule to the index creation server 250.

The index creation server 250 creates indexes according to the index creation rule, and further splits created index data according to the splitting rule. The splitting rule may include a splitting parameter. The splitting parameter may specifically include a splitting quantity. The splitting quantity is used to represent a quantity of pieces of data into which the index data is to be split. For example, when the splitting quantity is N, it represents that the index data is split into N pieces of sub-index data. N may be a positive integer greater than or equal to 2 to indicate that the created index data is stored in at least two engine servers 260 in a distributed manner. For example, search_online_dis_1 and search_online_dis_2 constitute a complete piece of index data, and may be split into two pieces of index data according to the splitting rule. The two pieces of index data may be separately stored in one engine server.

Furthermore, the index creation server 250 may generate index configuration information based on the index data obtained after creation and splitting. There may be a plurality of pieces of index configuration information, or the index configuration information may include a plurality of pieces of sub-index configuration information. The plurality of pieces of index configuration information or the plurality of pieces of sub-index configuration information may represent a splitting result of the index data, and includes each engine server 260 corresponding to each piece of sub-index data after the splitting. Each piece of index configuration information or each piece of sub-index configuration information is used to indicate which pieces of index data are correspondingly obtained and stored by the corresponding engine server 260. The notification module 220 may obtain index configuration information, and send the index configuration information to the master control module 210, so that the master control module 210 further instructs a corresponding client module 230 to pull index data.

That the master control server obtains index data based on the index configuration information, and stores the index data in at least two engine servers may specifically include: instructing, by the master control module 210 based on the index configuration information, a first client module 230 to obtain index data, where the first client module 230 is any client module corresponding to the splitting result included in the index configuration information; and storing, by the first client module 230, the obtained index data in an engine server 260 corresponding to the first client module 230. Specifically, the master control module 210 may indicate, according to an engine server 260 corresponding to the index data included in any piece of index configuration information or any piece of sub-index configuration information, a first client module 230 corresponding to the engine server 260. In this way, the first client module 230 may pull corresponding index data based on the indication of the master control module 210, and store the pulled index data in an engine server 260 corresponding to the first client module 230.

It should be understood that the distributed search method of this embodiment is a process of pulling and updating index data, and may be specifically an offline data processing process. Referring to FIG. 2, a data processing process that combines the servers and modules may be as follows:

Step 21: A master control module 210 obtains a splitting rule and an index creation rule from a configuration management server 240. As an implementation, the master control module 210 may obtain, according to a service type of to-be-created index data, a splitting rule and an index creation rule that match the service type.

Step 22: The master control module 210 sends the splitting rule and the index creation rule to a notification module 220.

Step 23: The notification module 220 sends the splitting rule and the index creation rule to an index creation server 250.

The index creation server 250 may create index data according to the index creation rule, and split the index data into N pieces of sub-index data according to the splitting rule. In addition, the index creation server 250 may generate a plurality of pieces of index configuration information or a plurality of pieces of sub-index configuration information based on the index data obtained after creation and splitting. Each piece of index configuration information or each piece of sub-index configuration information may represent the splitting result of the index data, and includes each engine server 260 corresponding to each piece of sub-index data after the splitting, thereby representing which pieces of index data are correspondingly obtained and stored by the corresponding engine servers 260.

Step 24: The index creation server 250 sends index configuration information to the notification module 220.

Step 25: The notification module 220 sends the index configuration information to the master control module 210. There may be a plurality of notification modules 220. The plurality of notification modules 220 may perform functional configuration according to different service types, that is, different notification modules perform notification functions for corresponding service types. In this way, the master control module 210 may obtain a splitting rule and an index creation rule according to a service type, and send the obtained splitting rule and index creation rule to a notification module 220 that matches the service type. Correspondingly, the index creation server 250 may send index configuration information to the notification module 220 that matches the service type. It should be understood that the plurality of notification modules may work concurrently.

Step 26: The master control module 210 indicates a client module 230 according to the index configuration information. As an implementation, the master control module 210 may indicate, according to an engine server 260 corresponding to the index data included in any piece of index configuration information or any piece of sub-index configuration information in a plurality of pieces of index configuration information, a client module 230 corresponding to the engine server 260. In this way, the client module 230 may pull corresponding index data based on the indication of the master control module 210, and store the pulled index data in an engine server 260 corresponding to the client module 230.

According to the technical solution in this embodiment of the present disclosure, the engine server 260 only needs to load corresponding index data, and an update function of the index data is mainly implemented by using a master control server (which may be specifically a client module in the master control server), thereby greatly reducing the load of a server. The index data is stored in a plurality of engine servers 260 in a distributed manner, memory usage of the engine server 260 can be greatly reduced in a search process, thereby effectively improving search efficiency, reducing a search response time, and improving operation experience for users.

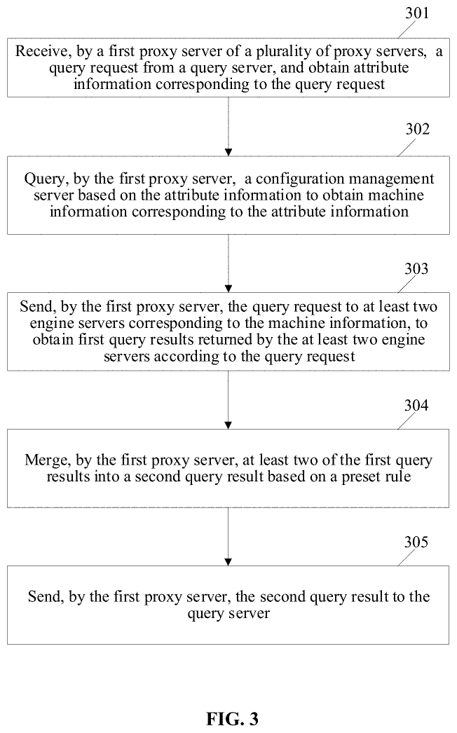

An embodiment of the present disclosure further provides a distributed search method. FIG. 3 is a schematic flowchart of a distributed search method according to another embodiment of the present disclosure. As shown in FIG. 3, the method may include the following steps.

Step 301: A first proxy server of a plurality of proxy servers receives a query request from a query server, and obtains attribute information corresponding to the query request.

Step 302: The first proxy server queries a configuration management server based on the attribute information to obtain machine information corresponding to the attribute information.

Step 303: The first proxy server sends the query request to at least two engine servers corresponding to the machine information to obtain first query results returned by the at least two engine servers according to the query request.

Step 304: The first proxy server merges at least two of the first query results into a second query result according to a preset rule.

Step 305: The first proxy server sends the second query result to the query server.

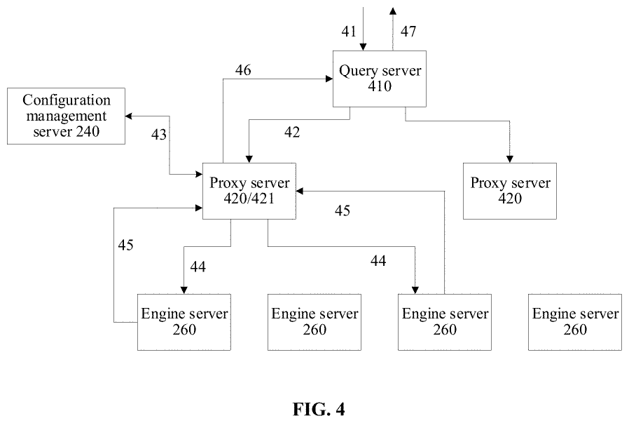

The distributed search method of this embodiment may be applied to a plurality of proxy servers, and each of the plurality of proxy servers may include the same function. FIG. 4 is a schematic diagram of an application architecture and data exchange of a distributed search method according to an embodiment of the present disclosure. As shown in FIG. 4, an example in which there are two proxy servers is used for description in this embodiment.

After receiving a query request of a terminal device from a user, a query server 410 sends the query request to at least one first proxy server 421 of a plurality of proxy servers 420 according to a preset rule. The preset rule may be a polling rule or a randomization rule. During actual application, the plurality of proxy servers 420 may be numbered in advance. The polling rule may be sequentially selecting, based on an order of the numbers of the plurality of proxy servers 420, one or more proxy servers as first proxy servers to which the query request is sent. For example, a query request is sent to one proxy server. When the query server 410 receives a first query request, the first query request may be sent to a proxy server 420 that is numbered 1. When the query server 410 receives a second query request, the second query request may be sent to a proxy server 420 that is numbered 2. The rest may be deduced by analogy. The first query request and the second query request may be determined according to data receiving time. The randomization rule may be sending the received query request to at least one corresponding proxy server 420 according to a preset randomization algorithm.

The first proxy server 421 obtains attribute information corresponding to the query request, and the attribute information may be a service type corresponding to the query request, so that the machine information may be requested from the configuration management server 240 based on the service type. Refer to the foregoing descriptions for a specific description of the configuration management server 240, and details are not described herein again. In addition, it can be learned from the foregoing descriptions that when the index data in the engine server 260 is updated and stored, the index data may be split based on a splitting rule. Therefore, index data that belongs to a same service type may be stored in at least two engine servers 260.

Based on this, in this embodiment, a first proxy server queries the configuration management server 240 to obtain machine information corresponding to the attribute information. The machine information may include identifiers of at least two engine servers 260, and the identifiers of the at least two engine servers 260 may indicate that index data corresponding to the query request is stored in the at least two engine servers. In a specific implementation process, the machine information may be implemented by using a machine list. Therefore, the first proxy server 421 may send the query request to the at least two corresponding engine servers 260 according to the machine information to obtain index data corresponding to a key character or keyword or an associated key character or associated keyword included in the query request.

As an implementation, that the first proxy server 421 obtains first query results returned by the at least two engine servers 260 may include: obtaining, by the first proxy server 421, the first query results that meet a preconfigured truncation parameter.

Specifically, the truncation parameter indicates a quantity of pieces of index data in the query results returned by any engine server 260. For example, if the query results obtained by one engine server 260 include 1000 pieces of index data and the truncation parameter is 600, the engine server 260 returns the first 600 pieces of index data of the 1000 pieces of index data. In this way, search latency can be greatly reduced and there can be many more queries per second (QPS). The truncation parameter may be configured by the configuration management server 240. The master control module 210 in the master control server obtains the truncation parameter, and sends the truncation parameter to each engine server 260 for configuration.

In this embodiment, the first proxy server 421 obtains first query results returned by the at least two engine servers 260, merges and sorts at least two of the first query results according to a preset rule to generate a second query result, and sends the second query result to the query server 410, so that the query server 410 sends the second query result to a terminal device to output and display the second query result to a user.

It should be understood that the distributed search method of this embodiment is a search query process, and may be specifically an online data processing process. Referring to FIG. 4, a data processing process that combines the servers is as follows:

Step 41: A query server 410 obtains a query request of a terminal device.

Step 42: The query server 410 sends the query request to at least one first proxy server 421 of the plurality of proxy servers 420. The first proxy server 421 may be one of the plurality of proxy servers 420 that corresponds to the service type of the query request, or may be one proxy server determined based on a preset rule (for example, a polling rule or a randomization rule).

The query server 410 may analyze the received query request to obtain both a key character or keyword in the query request and an associated key character or associated keyword that has an association relationship with the key character or keyword, that is, perform intention recognition on the query request. For example, if a key character or keyword included in the query request is the name of a restaurant, after intention recognition is performed on the key character or keyword, an associated key character or associated keyword “food ordering” or “takeaway” may be obtained. For another example, if a key character or keyword included in the query request is a character string, it is determined through intention recognition that the character string is the pinyin of a Chinese word and the corresponding associated key character or associated keyword may be the Chinese word or the like. The query server 410 may further generate at least one query request based on at least one a keyword obtained after intention recognition and send the at least one query request to at least one corresponding first proxy server 421.

Step 43: The first proxy server 421 requests a machine list from a configuration management server 240 based on attribute information (for example, a service type) of the query request, so as to obtain information of an engine server 260 in which index data corresponding to the query request is located.

Step 44: The first proxy server 421 sends the query request to at least two corresponding engine servers 260 based on the obtained machine list.

Step 45: The at least two engine servers 260 loads index data based on content in the query request, and returns query results to the first proxy server 421. The engine server 260 may control a quantity of pieces of index data in the query results based on a preconfigured truncation parameter, so as to reduce query latency and improve a QPS.

Step 46: The first proxy server 421 merges and sorts the obtained at least two query results according to a preset rule to generate a final query result, and sends the final query result to the query server 410.

Step 47: The query server 410 sends the final query result to a terminal device, so that the terminal device outputs and displays the final query result to a user.

By means of an architecture in which a query server 410 and an engine server 260 are linked together by a plurality of proxy servers 420, a query request from the query server 410 may be sent to at least one corresponding proxy server 420, and the at least one proxy server 420 obtains query results from at least two corresponding engine servers 260. The plurality of proxy servers 420 may have the same function, and a parallel relationship may exist between the plurality of proxy servers 420. In this way, when one proxy server 420 fails, another proxy server 420 may be used instead. In this way, it can be effectively avoided that a search service is temporarily unavailable when a master device fails and it is necessary to reselect a master device. In addition, the proxy servers 420 do not need to update or maintain indexes, thereby greatly reducing the load of the proxy servers 420.

An embodiment of the present disclosure further provides a distributed search system. Refer to FIG. 4 and FIG. 2 for details of the distributed search system. The system may include a configuration management server 240, a query server 410, a plurality of proxy servers 420, and a plurality of engine servers 260.

The configuration management server 240 may be configured to manage configuration information and machine information. The configuration information may include a splitting rule. The machine information may represent information of the plurality of engine servers.

The proxy server 420 may be configured to: obtain, when receiving a query request sent by the query server 410, attribute information corresponding to the query request, and query the configuration management server 240 based on the attribute information to obtain machine information corresponding to the attribute information, so as to send the query request to at least two engine servers 260 corresponding to the machine information. In addition, after obtaining first query results returned by the at least two engine servers 260 in response to the query request, the proxy server 420 may merge at least two of the first query results into a second query result according to a preset rule, and send the second query result to the query server 410.

The query server 410 may be configured to: send, when obtaining the query request of a terminal device, the query request to the proxy server 420, and send the second query result to the terminal device when receiving the second query result.

Each of the plurality of engine servers 260 may be configured to: store index data that meets the splitting rule, and return the first query results when receiving the query request.

In this embodiment, the system may further include a master control server and an index creation server 250. The master control server may be configured to: obtain a splitting rule from the configuration management server 240, and send the splitting rule to the index creation server 250. In addition, the master control module is further configured to: obtain index configuration information representing a splitting result sent by the index creation server 250, obtain index data based on the index configuration information, and store the index data in at least two corresponding first engine servers of the plurality of engine servers 260. The index creation server 250 may be configured to split to-be-created index data based on the splitting rule, and send the index configuration information representing the splitting result to the master control server.

As an implementation, the proxy server 420 may obtain query results that meet a preconfigured truncation parameter.

According to the distributed search system in this embodiment of the present disclosure, by means of a distributed search architecture in which a master control server, a configuration management server, an index creation server, a query server, and an engine server are linked by a plurality of proxy servers, a query function and an index update and maintenance function are respectively implemented by using proxy servers and the master control server, thereby greatly increasing the expandability of the distributed search system and the stability of the system. During actual application, statistics are collected on line by using a single index, the query latency is reduced by 50% in the first 50% of the time, the query latency is reduced by 54.5% in the first 90% of the time, and the query latency is reduced by 46% in the first 99% of the time, thereby improving user experience.

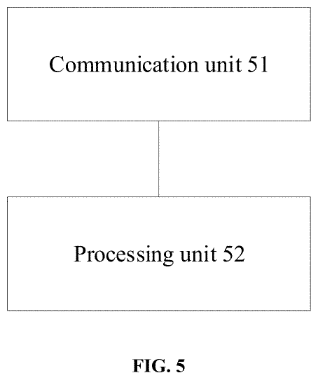

An embodiment of the present disclosure further provides a proxy server. FIG. 5 is a schematic structural diagram of a proxy server according to an embodiment of the present disclosure. As shown in FIG. 5, the proxy server may include a communication unit 51 and a processing unit 52.

The communication unit 51 may be configured to: receive a query request from a query server, and send the query request to the processing unit 52. The communication unit 51 is further configured to: send the query request to at least two engine servers determined by the processing unit 52 to obtain first query results returned by the at least two engine servers, and send a second query result merged by the processing unit 52 to the query server.

The processing unit 52 may be configured to: obtain attribute information corresponding to the query request, and query a configuration management server based on the obtained attribute information, to obtain the at least two engine servers corresponding to the attribute information. The processing unit 52 is further configured to merge at least two of the first query results obtained by the communication unit 51 according to a preset rule to obtain the second query result.

As an implementation, the communication unit 51 may obtain query results that meet a preconfigured truncation parameter.

The processing unit 52 in the proxy server may be implemented by a central processing unit (CPU), a digital signal processor (DSP), a microcontroller unit (MCU), or a field-programmable gate array (FPGA) in the proxy server. The communication unit 51 in the proxy server may be implemented by a communication assembly (including a basic communication suite, an operating system, a communication module, a standard interface, and a protocol) and a transceiver antenna.

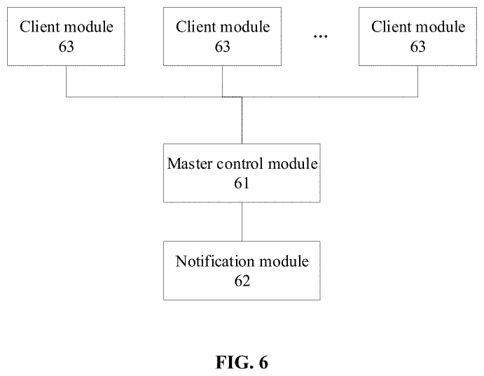

An embodiment of the present disclosure further provides a master control server. FIG. 6 is a schematic structural diagram of a master control server according to an embodiment of the present disclosure. As shown in FIG. 6, the master control server may include a master control module 61 and a notification module 62.

The master control module 61 may be configured to: obtain a splitting rule from a configuration management server, and send the splitting rule to the notification module 62.

The master control module 61 may further be configured to: obtain index data based on index configuration information sent by the notification module 62, and store the index data in at least two corresponding engine servers of a plurality of engine servers.

The notification module 62 may be configured to send the splitting rule to an index creation server, so that the index creation server splits to-be-created index data according to the splitting rule. In addition, the notification module 62 may further obtain index configuration information representing a splitting result, and send the index configuration information to the master control module 61.

In this embodiment, the master control server may further include a plurality of client modules 63. The plurality of client modules 63 may be in a one-to-one correspondence with a plurality of engine servers. The master control module 61 may indicate, based on index configuration information sent by the notification module 62, a client module 63 corresponding to the splitting result included in the index configuration information to obtain index data. During actual application, the master control module 61 may include: a first communication submodule, configured to communicate with the configuration management server to obtain the splitting rule from the configuration management server; a second communication submodule, configured to communicate with the notification module 62 to send the splitting rule to the notification module 62 and obtain the index configuration information from the notification module 62; and a third communication submodule, configured to communicate with a client module 63 to instruct the client module 63 to obtain the index data based on the index configuration information.

The notification module 62 may further be configured to: send the splitting rule to the index creation server, and send the index configuration information to the master control module 61 after obtaining the index configuration information representing the splitting result. During actual application, the notification module 62 may include: a first communication module, configured to communicate with the master control module 61 to obtain the splitting rule from the master control module 61 and send the index configuration information to the master control module 61; and a second communication module, configured to communicate with the index creation server to send the splitting rule to the index creation server and obtain the index configuration information from the index creation server.

The client module 63 obtains index data based on an indication of the master control module 61, and stores the index data in a corresponding engine server. During actual application, the client module 63 may include: a first communication submodule, configured to communicate with the master control module 61 to receive the indication of the master control module 61; a processing module, configured to obtain the index data in response to the indication of the master control module 61 based on the index configuration information; and a second communication submodule, configured to communicate with the engine server to store the index data in the corresponding engine server.

In this embodiment, the master control server may be a server cluster. The master control module 61 is mainly responsible for unified scheduling. The notification module 62 is mainly responsible for communicating with the index creation server. There may be at least one notification module 62. The at least one notification module 62 may be distinguished based on different service types. For example, each notification module 62 is configured to notify related information for creating indexes that belong to a corresponding service type. The quantity of the client modules 63 may be the same as the quantity of the engine servers, and each client module 63 corresponds to one engine server. The client module 63 pulls index data based on the indication of the master control module 61, and stores the pulled index data in a corresponding engine server. The master control module 61 and each notification module 62 may be implemented by an independent server. The client module 63 may be located in the corresponding engine server, and implements a corresponding function by using the corresponding engine server. During actual application, the master control module 61 may be configured with a standby master control module. Each notification module 62 may be configured with a corresponding standby notification module. Each client module 63 may be configured with a corresponding standby client module 63. In this way, when a master module encounters an exception and fails, a corresponding standby module can continue to perform a corresponding function.

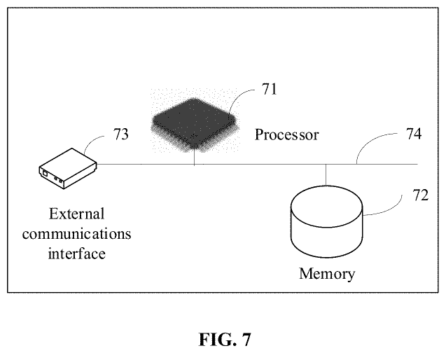

An embodiment of the present disclosure further provides a computer device. FIG. 7 is a schematic structural diagram of a computer device according to an embodiment of the present disclosure. As shown in FIG. 7. The computer device may include a processor 71, a memory 72, and at least one external communication interface 73. The processor 71, the memory 72, and the external communication interface 73 may all be connected by a bus 74. Computer programs that can be run on the processor 71 are stored in the memory 72.

When the computer device is used as a proxy server, the processor 71 executes the programs to implement the following steps: receiving a query request from a query server; obtaining attribute information corresponding to the query request; querying a configuration management server based on the attribute information to obtain machine information corresponding to the attribute information; sending the query request to at least two engine servers corresponding to the machine information; obtaining first query results returned by the at least two engine servers according to the query request; merging at least two of the first query results into a second query result according to a preset rule; and sending the second query result to the query server. That is, the processor 71 may implement specific functions of the communication unit 51 and the processing unit 52 as shown in FIG. 5 by executing the programs.

As an implementation, the processor 71 executes the programs to implement the following step: obtaining query results that meet a preconfigured truncation parameter.

When the computer device is used as a master control server, the processor 71 executes the programs to implement the following steps: obtaining a splitting rule from the configuration management server; sending the splitting rule to an index creation server, so that the index creation server splits to-be-created index data according to the splitting rule; obtaining index configuration information representing a splitting result; obtaining index data based on the index configuration information; and storing the index data in at least two corresponding first engine servers of a plurality of engine servers. That is, the processor 71 may execute the programs to implement specific functions of the master control module 61, the notification module 62, and the client module 63 that are shown in FIG. 6.

It should be noted herein that, the foregoing descriptions of the computer device are similar to the foregoing descriptions of the method, and the beneficial effects same as those of the methods are not described herein again. Refer to the descriptions of the method embodiments of the present disclosure for technical details that are not disclosed in the embodiments of the computer device of the present disclosure.

In the embodiments provided in this application, it should be understood that the devices and methods disclosed herein may be implemented in other manners. The foregoing described device embodiments are merely exemplary. For example, the division of the units is merely a logical function division and there may be other division manners in actual implementation. For example, a plurality of units or components may be combined or integrated into another system, or some features may be ignored or may not be performed. In addition, the shown or discussed mutual couplings, direct couplings or communication connections between the components may be indirect couplings or communication connections through some interfaces, devices, or units, or may be in electrical, mechanical, or other forms.

The units used as separate parts for description may be or may not be physically separate. The parts shown as units may be or may not be physical units. That is, the parts may be located in a same place, or may be distributed to many network units. Some or all units may be selected according to actual requirements to achieve the objective of the solution of the embodiments. For example, various servers in the foregoing may be one physical hardware machine, or may be one software module run on a server cluster.

In addition, different functional units in the embodiments of the present disclosure may be all integrated in one processing unit, or each unit is separately used as one unit, or two or more units are integrated in one unit; the integrated unit may be implemented in the form of hardware, or may be implemented in the form of hardware plus a software functional unit.

A person of ordinary skill in the art may understand that, all or some steps of the foregoing method embodiments may be implemented by using a program to instruct relevant hardware. The foregoing program may be stored in a computer-readable storage medium, and when the program is executed, the steps of the method embodiments are performed. The foregoing storage medium includes: a removable storage device, a read-only memory (ROM), a random access memory (RAM), a magnetic disk, an optical disc, or another medium that can store program code.

Alternatively, when the integrated unit in the present disclosure is implemented in the form of a software functional module and is sold or used as an independent product, the integrated unit may be stored in a computer-readable storage medium. Based on such an understanding, the technical solutions of the embodiments of the present disclosure essentially, or the part contributing to the prior art may be implemented in the form of a software product. The computer software product may be stored in a storage medium, including several instructions for instructing a computer device (which may be a personal computer, a server, or a network device) to perform all or some parts of the methods in the embodiments of the present disclosure. The foregoing storage medium includes: a removable storage device, a ROM, a RAM, a magnetic disk, an optical disc, or another medium that can store program code.

The foregoing descriptions are only specific implementations of the present disclosure, and the protection scope of the present disclosure is not limited thereto. Any change or replacement readily conceivable by a person skilled in the art without departing from the technical scope disclosed in the present disclosure shall fall within the protection scope of the present disclosure. Therefore, the protection scope of the present disclosure should be subject to the appended claims.

1. A distributed search method, comprising:
obtaining, by at least one first proxy server of a plurality of proxy servers after receiving a query request from a query server, attribute information corresponding to the query request;
querying, by the first proxy server, a configuration management server based on the attribute information to obtain machine information corresponding to the attribute information;
sending, by the at least one first proxy server, the query request to at least two engine servers corresponding to the machine information;
obtaining, by the at least one first proxy server, first query results returned by the at least two engine servers according to the query request;
merging, by the at least one first proxy server, at least two of the first query results into a second query result according to a preset rule; and
sending, by the at least one first proxy server, the second query result to the query server.

2. The method according to claim 1, wherein obtaining, by the first proxy server, the first query results returned by the at least two engine servers according to the query request comprises:
obtaining, by the first proxy server, the first query results that meet a preconfigured truncation parameter.

3. The method according to claim 1, further comprising:
choosing at least one proxy server having a service type matching the query request from the plurality of proxy servers as the first proxy server.

4. The method according to claim 1, further comprising:
choosing at least one of the plurality of proxy servers as the first proxy server according to a preset rule, wherein
the preset rule comprises a randomization rule and a polling rule.

5. An index update method, comprising:
obtaining, by a master control server, a splitting rule from a configuration management server;
sending, by the master control server, the splitting rule to an index creation server, to facilitate the index creation server to split to-be-created index data according to the splitting rule;
obtaining, by the master control server, index configuration information representing a splitting result;
obtaining, by the master control server, index data based on the index configuration information; and
storing, by the master control server, the index data in at least two corresponding engine servers of a plurality of engine servers.

6-8. (canceled)

9. A distributed search system, comprising:
a configuration management server, configured to manage configuration information and machine information, wherein the configuration information comprises a splitting rule, and the machine information represents information of a plurality of engine servers;
a query server, configured to obtain a query request of a terminal device;
a plurality of proxy servers; and
a plurality of engine servers, wherein each of the plurality of engine servers is configured to store index data that meets the splitting rule, wherein
after receiving the query request from the query server, at least one first proxy server of the plurality of proxy servers queries the configuration management server based on attribute information of the query request, determines at least two first engine servers of the plurality of engine servers, and sends the query request to the at least two first engine servers;
the at least two first engine servers return first query results in response to the query request; and
the at least one first proxy server merges at least two of the first query results into a second query result, and sends the second query result to the query server to facilitate the query server to return the second query result to the terminal device.

10. The system according to claim 9, further comprising:
a master control server, configured to obtain the splitting rule from the configuration management server; and
an index creation server, configured to: split to-be-created index data based on the splitting rule sent by the master control server, and send index configuration information representing a splitting result to the master control server; and, wherein
the master control server is further configured to obtain index data based on the index configuration information, and to store the index data in at least two corresponding engine servers of the plurality of engine servers.

11. The system according to claim 9, wherein the first engine servers are configured to return the first query results to the first proxy server based on a preconfigured truncation parameter.

12. The system according to claim 9, wherein the query server is configured to send the query request to the first proxy server of the plurality of proxy servers whose service type matches the service type of the query request.

13. The system according to claim 9, wherein the query server is configured to choose at least one of the proxy servers as the first proxy server according to a preset rule, and sends the query request to the first proxy server.

14-15. (canceled)
